(19) United States
(12) Patent Application Publication
(10) Pub. No.: US 2026/0195180 A1
(43) Pub. Date: Jul. 9, 2026

(54) MAP-BASED TASK SCHEDULING

(71) Applicant: Oracle International Corporation, Redwood Shores, CA (US)

(72) Inventors: Rahul Singh, Telangana (IN); Vishal Kulkarni, Telangana (IN); Aditya Kumar Singh, Telangana (IN); Jaideep C. Bhatia, Pleasanton, CA (US)

(73) Assignee: Oracle International Corporation, Redwood Shores, CA (US)

(21) Appl. No.: 19/009,727

(22) Filed: Jan. 3, 2025

(51) Int. Cl. G06F 9/50

(52) U.S. Cl. CPC G06F 9/5027

(57) ABSTRACT

Systems, computer-readable media, and methods are described for causing display of a map and receiving configuration input to map controls filtering out resources to select a subset of unfiltered resources. The map is displayed in a filtered state showing at least a particular resource of the subset at a particular resource location associated with the particular resource without showing the filtered resources on the map. While the map is in the filtered state, a selection of a particular task item is received and the particular resource is automatically scheduled to complete the particular task item a particular status of the particular task item is automatically updated, a resource task schedule is automatically updated for the particular resource to include the, and the map is automatically updated to include an indication that is based at least in part on both the particular task location and the particular resource location.

### BACKGROUND

Schedule management of resources of an organization often causes confusion and inefficiencies. When scheduling a task to be performed by a resource, the task may be added to the schedule of the resource without regard for other factors such as whether enough travel time has been accounted for between the prior location and the new scheduled task. Visual user interfaces have not addressed these issues of scheduling as Gantt charts, or other bar charts that show task schedules, are limited in their ability to depict how different tasks may be more optimized if scheduled differently.

### BRIEF SUMMARY

In some embodiments, a system, article, and computer-implemented method are disclosed for causing display of a map and receiving configuration input to map controls filtering out resources to select a subset of unfiltered resources. The map is displayed in a filtered state showing at least a particular resource of the subset at a particular resource location associated with the particular resource without showing the filtered resources on the map. While the map is in the filtered state, a selection of a particular task item is received and the particular resource is automatically scheduled to complete the particular task item a particular status of the particular task item is automatically updated, a resource task schedule is automatically updated for the particular resource to include the, and the map is automatically updated to include an indication that is based at least in part on both the particular task location and the particular resource location.

A computer-implemented method includes causing display of a map, one or more map controls, and one or more selectable task items and receiving configuration input to the one or more map controls, the configuration input filtering out one or more filtered resources of a plurality of candidate resources to select a subset of one or more unfiltered resources of the plurality of candidate resources. The method also includes causing display of the map in a filtered state, the filtered state of the map showing at least a particular resource of the subset at a particular resource location associated with the particular resource without showing the one or more filtered resources on the map. While the map is in the filtered state, a selection of a particular task item of the one or more selectable task items is received and based at least in part on the selection of the particular task item, the particular resource is automatically scheduled to complete the particular task item at a particular task location associated with the particular task item within a particular time constraint of the particular task item, a particular status of the particular task item is automatically updated to indicate that the particular task item has been scheduled, a resource task schedule for the particular resource is automatically updated to include a particular entry for the particular task item at a particular time, the updated resource task schedule also including one or more other entries for one or more other task items scheduled at one or more other times, the map is automatically updated to include a graphical indication that is based at least in part on both the particular task location and the particular resource location.

In a further embodiment, the graphical indication includes one or more graphically displayed routes between the particular resource location and the particular task location.

In a further embodiment, the graphical indication includes a graphical marking that covers both the particular resource location and the particular task location.

In a further embodiment, the graphical indication includes metadata that is based on one or more metrics predicted for a trip between the particular resource location and the particular task location.

In a further embodiment, the computer-implemented method also includes, based at least in part on the selection of the particular task item, automatically adding one or more notification conditions to the particular entry based at least in part on a notification setting for an entity associated with the particular task item, determining whether the one or more notification conditions have been satisfied, and, in response to determining that the one or more notification conditions have been satisfied, triggering a notification to the entity.

In a further embodiment, receiving the selection of the particular task item of the one or more selectable task items includes receiving input that drags the particular task item from a task item region of a user interface to the map, which is in a map region of the user interface.

In a further embodiment, receiving the selection of the particular task item of the one or more selectable task items includes receiving a selection of the particular resource among two or more displayed resources of the subset.

In a further embodiment, the two or more displayed resources of the subset are displayed in an order sorted based at least in part on one or more characteristics of each of the two or more displayed resources in comparison with one or more corresponding characteristics of the particular task item.

In a further embodiment, the computer-implemented method also includes causing display of graphical indications of two or more characteristics of each of the two or more displayed resources to support receiving the selection of the particular resource.

In a further embodiment, the computer-implemented method also includes, in response to the selection of the particular task item, without receiving manual input selecting the particular resource from among two or more resources of the subset, automatically selecting the particular resource based at least in part on one or more characteristics of each of the two or more resources in comparison with one or more corresponding characteristics of the particular task item.

In some embodiments, a system is provided that includes one or more data processors and a non-transitory computer-readable storage medium containing instructions which, when executed on the one or more data processors, cause the one or more data processors to perform part or all of one or more methods disclosed herein.

In other embodiments, a computer-program product is provided that is tangibly embodied in a non-transitory machine-readable storage medium and that includes instructions configured to cause one or more data processors to perform part or all of one or more methods disclosed herein.

Cloud services, microservices, or other machine-hosted services may be offered that perform part or all of one or more methods disclosed herein. The machine-hosted services may be provided by a single machine, by a cluster of machines, or otherwise distributed across machines. The one or more machines may be configured to send and receive data, which may include instructions for performing the methods or results of performing the methods, via an application programming interface (API) or any other communication protocol.

In various embodiments, part or all of one or more methods disclosed herein may be performed by stored instructions such as a software application, computer program, or other software package installed in memory or other storage of a computing platform, such as an operating system, which provides access to physical or virtual computing resources. The operating system may provide access to physical or virtual resources of a mobile computing device, a laptop computing device, a desktop computing device, a server computing device, a container in a virtual machine on a computing device, or any other computing environment configured to execute stored instructions.

As used herein, the terms “first,” “second,” “third,” “fourth,” etc. are used as naming conventions to refer to separate items in a set of items. These naming conventions do not imply ordering unless such ordering is explicitly noted using language specific to ordering, such as “before” or “after,” or unless such ordering is required to attain the expressly recited functionality, such as generating an item and later accessing the generated item.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

Various embodiments are described hereinafter with reference to the figures. It should be noted that the figures are not drawn to scale and that the elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure.

FIG. 1 illustrates a flow chart of an example process for scheduling tasks of resources.

FIG. 2 illustrates a system diagram showing an example cloud infrastructure for managing task scheduling.

FIG. 3 illustrates a diagram of an example user interface showing task information.

FIGS. 4A and 4B illustrate a diagram of an example user interface showing map and task information for assigning tasks for scheduling via a map interface.

FIG. 5 illustrates a diagram of an example user interface showing scheduling of tasks with a plurality of resources available.

FIG. 6 illustrates a diagram of an example user interface showing trip planning for performance of a task.

FIG. 7 illustrates a diagram of an example user interface showing a planboard view of a schedule after assigning a task to the schedule.

FIG. 8 depicts a simplified diagram of a distributed system for implementing certain aspects.

FIG. 9 is a simplified block diagram of one or more components of a system environment by which services provided by one or more components of an embodiment system may be offered as cloud services, in accordance with certain aspects.

FIG. 10 illustrates an example computer system that may be used to implement certain aspects.

### DETAILED DESCRIPTION

Systems, methods, and computer-readable media are disclosed for filtering options of resources displayed with a map, of which one is selected by a user to assign a selected task, and the task is automatically assigned to a schedule of the selected resource. In various embodiments, the schedule management system is implemented using non-transitory computer-readable storage media to store instructions which, when executed by one or more processors of a computer system, cause display of the user interface and processing of the received input to schedule tasks. The schedule management system may be implemented on a local and/or cloud-based computer system that includes processors and a user device display for showing the user interface to a user for managing task schedules. The computer system may communicate with client computer systems for task schedule management.

A description of a schedule management system is provided in the following sections:
TASKS AND RESOURCES
TASKS DISPLAYED IN USER INTERFACE
SCHEDULING VIA THE MAP INTERFACE
UPDATING INTERFACE AND DATA AFTER TASK ASSIGNMENT
TRIP PLANNING
COMPUTER SYSTEM ARCHITECTURE

The steps described in individual sections may be started or completed in any order that supplies the information used as the steps are carried out. The functionality in separate sections may be started or completed in any order that supplies the information used as the functionality is carried out. Any step or item of functionality may be performed by a personal computer system, a cloud computer system, a local computer system, a remote computer system, a single computer system, a distributed computer system, or any other computer system that provides the processing, storage and connectivity resources used to carry out the step or item of functionality.

### Tasks and Resources

A task is an action to be performed by a member of an organization at one or more designated locations and may require a specific type of resource for completion. Tasks may have defined requirements, such as a resolve-by date before which the task should be performed, a specific time of the day for performance of the task, a skill requirement for members of an organization performing the task, or a parts requirement for an item required for performance of the task. Performance of tasks may be constrained by one or more rules laid out by a contract with a client that determines restrictions for performance of tasks, such as a time window for each day when any tasks for that client must be performed. Tasks may be received as a request for service by a client which is then processed into a generated task within the schedule management system. A request for service may generate one or more tasks as the work required to be performed for complete performance of a requested service may require a greater amount of time than is available within the bounds of a single task. Location(s) to navigate to for starting and/or ending a shift or necessary extra steps, such as acquiring other resources outside of an assigned task, may be represented as internal tasks. Tasks may be performed with the aid of a resource of the organization to fulfill performance of a requested service.

A resource may be any type of moveable person, item, or entity required for completion of a task. A resource may be, for example, a technician or specialist. Resources may also track items or tools such as vehicles separate from members of an organization that operate them. Resources may be associated with a territory or a geographic region that sets bounds on the tasks assigned to that resource based on the location of the tasks being within the same region. In this way, resource travel time is passively bounded to a maximum based on the size of the territory defined for the resource. Users may define the territories by a number of zip codes, a geographic region, or arbitrarily by selection of territory boundaries. Resources may be assigned to a territory, in which case resources may be automatically selected as part of a selected plurality of resources when selecting their assigned territory. When a task is received, the schedule management system may perform an address match for an address assigned for that task to determine a territory that best fits the assigned address for the task.

Resources may have a schedule that is populated with one or more tasks for each day that directs the resource as to what tasks to perform, when to perform them, and any travel necessary between task locations. One or more resources may be used in the completion of a task and may therefore need to be scheduled separately such that all resources of the one or more resources will be at a location for the performance of a task at the time of the task performance. The schedule may have a designated time window within which tasks may be scheduled designated as a shift of the resource for a given day. A shift may be defined by a shift start time and a shift end time. A shift may be defined with standard shift start and shift end times for a resource for each working day of the resource. A shift may also be altered to have alternate shift start or shift end times, such as when extending a shift to designate available overtime within a shift of a given day for a resource.

When a task is added to a resource's schedule, that task is said to be scheduled. Task assignment or scheduling may be performed manually, by input of a user, or automatically by a schedule management system utilizing a set of rules. A task may not necessarily be displayed to a resource on that resource's schedule until after the task is committed to the resource's schedule. Committing a task to a schedule may be any form of action performed to confirm a task's placement in a schedule of a resource. Committed tasks in a schedule may be unchangeable when optimizing a schedule by altering scheduled times for scheduled tasks.

When scheduling a task within a resource's schedule, the schedule management system may automatically define a trip, or a path that the resource must navigate between a current location of the resource and the task location designated for performance of the task. Trips may be a part of a collective trip of a whole schedule designated for a resource for that resource's shift, including a starting and ending location of the shift.

A task may have a part requirement. Parts may be resources or objects required for a completion of the task. Data of a resource may record a current stock of parts for that resource, such as a trunk stock of available parts to a technician in the field. A stock of parts may be available elsewhere, accessible to a resource such as a warehouse or service hub location. Parts may also be acquired when unavailable in any current stock of parts available by creating and submitting a requisition request for the part. Tasks or trips may be assigned for a resource to retrieve a part from a location such that the resource may complete a future task assigned to that resource.

In one example, an organization may manage scheduling of tasks for a number of technicians for servicing electronic terminals for a plurality of clients. Those electronic terminals may be at a fixed location, such that when a task is received for servicing a particular electronic terminal, the task may be automatically assigned the task location of the fixed location of the particular electronic terminal. Tasks may be received as service requests from clients contracted with the organization. Tasks may also be directed by contract such as regular service tasks.

When scheduling tasks for one or more resources'schedules, the schedule management system may automatically perform schedule optimization by assigning tasks to resources and checking for an optimal schedule of tasks for a resource using geospatial data, skills data, parts availability, and territory definitions to perform graph algorithms or nearest neighbor searches.

### Tasks Displayed in User Interface

A user interface may display a list of tasks and a map for scheduling tasks of an organization. The user interface may contain a task region for displaying tasks that are to be scheduled or yet to be committed to a schedule. The task region may be displayed concurrently with a map region, displaying data about one or more resources which may be assigned tasks for scheduling within their schedules. In one example, the user interface is a webpage with the task region and map region rendered in HTML.

The task region may display a plurality of tasks of a total list of tasks available. The plurality of tasks may be displayed with data associated with each task such as metadata of the task including a task number, a task description, location information such as an address for performance of the task as well as a region, state or country for the task, a customer associated with the task, a resource assigned to the task, dates associated with the task, an expected time duration of task performance, a task type, a task priority, a task owner, and any requirements of the task such as parts or skill requirements. A task number may be an assigned ID number for a task that may be used as a unique identifier of that task. Task numbers may be used to identify a specific task within the schedule management system. A task may have an associated location for performance of the task which may be utilized by the schedule management system in displaying locations of scheduled tasks on the map region or when performing schedule optimizations based on travel time. A task may also have a plurality of associated locations for performance of a task, such as a primary location and one or more secondary potential locations where performance of the task is still possible. The one or more dates associated with the task may include a first possible date of performance, a resolve-by date or final date that the task may be performed, a planned start or end date or time for the task which may define a suggested best time window within which to schedule the task, or a scheduled start or end date which are populated when scheduling the task and may be empty when a task is displayed if the task is not yet scheduled. A resolve-by date and a first possible date of performance define a time window in which the task may be performed. A task may be prohibited from scheduling in a time outside the time window in which the task may be performed. If a first possible date of performance is not specified, the window in which to perform the task may be from the date of task creation to the resolve-by date. An assigned resource may also be displayed with a task if the task is scheduled with a resource, however, this value may also be empty when displaying the task if the task has not yet been scheduled.

The task region may contain one or more controls for managing the current view of tasks available. For example, the task region may contain a filtering control for limiting the list of currently displayed tasks out of a list of total tasks based on a selected filter. For example, the current view of tasks available may be filtered to only display tasks for a selected client of a list of clients.

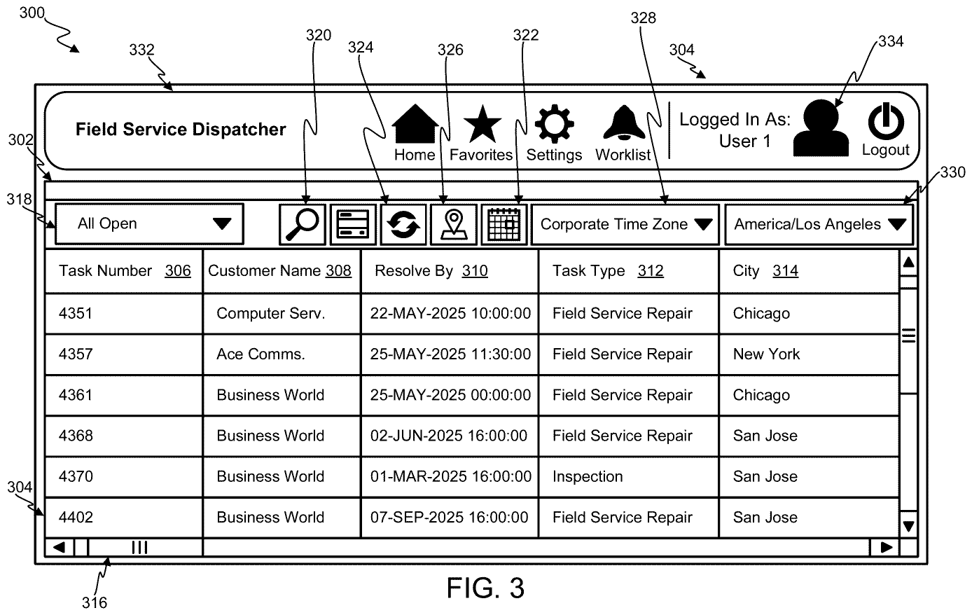

FIG. 3 depicts a user interface 300 with a task region 302 displaying a plurality of tasks. A task 304 of the plurality of tasks contains values for a task number 306, a customer name 308, a resolve-by date 310, a task type 312, and a city 314. The information fields 306-314 displayed for the plurality of tasks is a representation of possible display information and may be a subset of the total information for the task. The user interface 300 may include one or more navigation controls 316 for displaying further information of the plurality of tasks. The user interface 300 may also include an option 318 for filtering displayed tasks, such as by selecting a value of one of the fields of data 306-314 to filter out records not containing the same value in the selected field. The user interface 300 may also display a search operation 320 for filtering displayed tasks by a search on the data of the plurality of tasks. The user interface 300 may also display a calendar option 322 for selecting to filter displayed tasks to tasks of a given date or date range. The user interface 300 may also contain an option 324 to refresh the user interface 300 so as to load the most recent data of the plurality of tasks from a schedule management service. The user interface may also contain an option 326 to display a map region such as to display the location of the task 304 on a map display. The user interface 300 may also display one or more time display settings 328 for setting the time zone to use in displaying time values of the plurality of tasks. The user interface 300 may also display a territory option 330 for filtering displayed tasks by assigned territory based on the task location. The user interface 300 may also contain a persistent header region 332 for controlling the display of the user interface 300. The user interface 300 may display the information within the user interface based on a set of user credentials registered to a user 334 of the user interface 300. The display of the user interface 300 may be configured by one or more settings associated with the user credentials of the user 334 and data displayed within the user interface 300 may be restricted by the user credentials of the user 334.

### Scheduling via the Map Interface

The user interface may display a map region for displaying resource and task locations, displaying trips of resources, and for facilitating scheduling of tasks with assigned resources. The map region may be displayed concurrently with the task region such that both may be interacted with by a user within the same user interface. The map region and task region may be rendered in HTML as part of a web page user interface. The elements of the task table may be rendered as draggable entities such that tasks may be dragged to the map and elements of the map may be rendered as drop targets. The map region may display a map with rendered location markers to indicate locations of items on the map from XML formatted location data for each item, such as a resource or task location. These user interface elements allow for a user workflow of 1) locating a task of interest in an HTML-rendered task table, 2) identifying a resource on the map with an HTML rendered location marker indicating a location from XML-formatted location data, and 3) dragging and dropping the task of interest from the HTML table to the resource plotted on the map.

The map region may contain one or more settings for filtering the display of resources or trips on the map, such as a setting to select one or more resources as selected resources to be displayed. Another example of a filter setting is a setting to filter all resources that currently do not have any availability within their shift. The one or more settings for filtering the display of resources or trips may include criteria for selecting the type of item to display in the map, a territory for selecting a location to display within the map and to filter resources and trips to only those of the selected territory, and/or a range of date or times to be selected for filtering which trips will be displayed.

Based on the one or more settings for filtering the display of resources, a set of resources for display may be generated. The map region may display a resource location indicator on the map identifying a location for each resource of the set of resources. When a resource displayed with a resource location indicator on the map is selected, the map region may display a tooltip on the resource location. The tooltip may be an HTML text box displaying information about the selected item. The tooltip displayed for the resource may display information about the resource such as the name of the selected resource, current availability of the selected resource, and a shift start and end time for the resource. The tooltip may also display a selectable option to display a trip boundary for the given resource within which the resource may navigate. The tooltip may also include a task assignment region which, when a selected task is dragged from a table of tasks to the task assignment region, the task is assigned for the selected resource at that location. Resources may also be arranged or displayed based on metrics of the character, for example, a ratings average, a percentage of schedule already full, or a measure of timeliness.

A selected task may be dragged from the task region of the user interface to the map region of the user interface and onto the tooltip displayed for a selected resource. When a selected task is dropped onto a task assignment region for a resource tooltip, the task may be automatically assigned to that resource. The dragging and dropping functionality between the task region and the map region enhances the task table usability by enabling a user to prioritize service activity that efficiently traverses a resource between tasks with minimized travel time while also reducing the time required on the part of the user to generate an efficient schedule for a resource as scheduling may be performed with fewer actions and without needing to change between different data views of a task table.

The schedule management system may, in response to dropping the selected task on the map region, generate an event to indicate a task has been selected for assigning to a resource which may trigger one or more REST or other API calls utilizing the information of the selected task and the selected resource to schedule the selected task with the selected resource and update the information stored about the task. For example, the schedule management system may perform a REST call to retrieve all available plan options by retrieving the current schedule of the selected resource. The schedule management system may automatically assign the task to the selected resource within a selected time window or within the planned window of time for the task, comparing with the current schedule of the selected resource to find available times for scheduling the task.

The map region may display multiple tooltips simultaneously, each tooltip representing a different resource of a selected plurality of resources. The map region may have an option to select a currently displayed resource for display with a tooltip on the map such as by clicking each resource for which the user wishes the tooltip to be displayed. The option to select a currently displayed resource may allow the user to select one or more resources, each of which are to be displayed on the map with a tooltip.

Additional information such as metrics may be displayed within the map region. For example, the map region may display a metric of a most or least used resource for the time period selected. The metrics may be displayed concurrently with the map or on hover. The metrics may also display data for the territory, such as total travel time for a particular territory.

When hovering over the map region with a task, but not hovering over a particular resource, a suggestion may be displayed of a best or set of best resources to assign the task to. A suggested resource may be based on a determination of a closets resource based on starting location or any committed task locations within a resource's schedule. A suggested resource may also be based on skill or parts requirements.

### Updating Interface and Data After Task Assignment

After scheduling a task, one or more REST or other API calls may be made to alter or retrieve data based on the scheduled task. An API call may be used to alter the status of the task within a database to be scheduled. Further API calls may be used to add the information of the resource to the task data or to add the task data to the resource's schedule data. This may include the specified date or location for the task performance. A further function may refresh the page of a user submitting a scheduling such that the user's interface shows the most up-to-date data including their modifications. The map region may display a modified tooltip, displaying information previously displayed about the resource at the location assigned for the task, as well as any calculated information about the scheduled task such as data about a trip automatically scheduled for the task such as a total planned effort time, a departure time, arrival time, or a status of the task. When a task is scheduled, it may be committed to finalize the task's day and time of service. Committing a task may be a manual process by a user after reviewing the schedules and comparing trips using the user interface display. Committing tasks may be automatic, such as via a rule that automatically schedules currently scheduled tasks when a clock or timer reaches 24 hours before the shift. Every time a task transitions between different statuses, it may generate an event. Users may subscribe to events of changing task statuses by customizing notification settings for that type of event. A notification setting may be, for example, to only notify a user of a change to a status of a task assigned for resources of a certain selected subset. When a notification setting is created, the schedule management system may generate a notification condition for each of the tasks that fit within the notification setting. Event(s) may be triggered by the schedule management system by determining whether there are any existing notification conditions for corresponding event(s) and, if so, which users are to be notified corresponding to the notification setting(s). A notification is then generated for the affected user(s) to notify the user(s) of the changing task status.

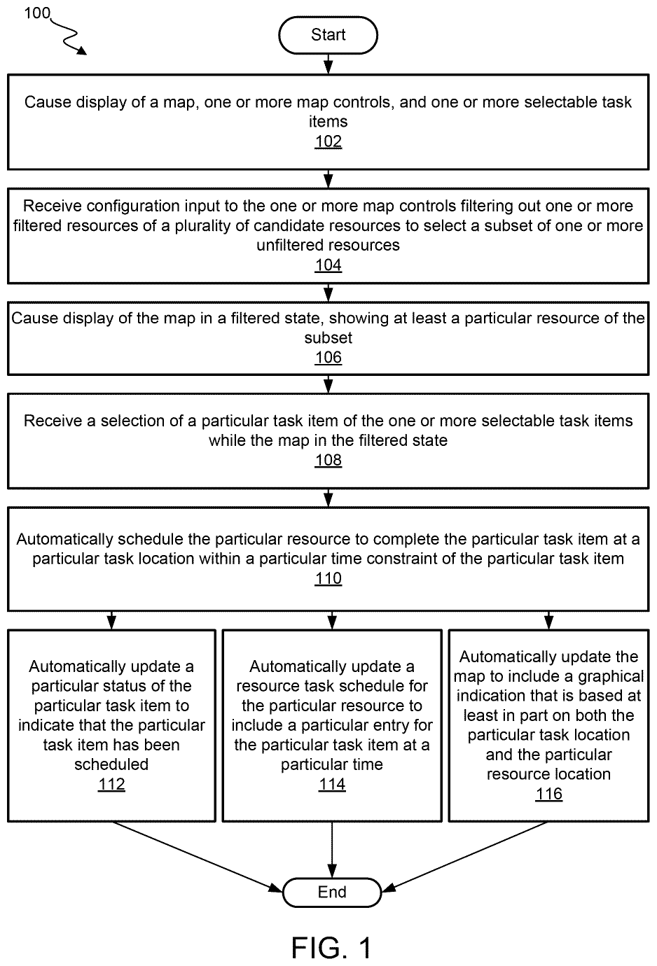

FIG. 1 depicts a method 100 for performing scheduling of tasks for a resource. In block 102, a map is displayed along with one or more map controls and one or more selectable task items. At block 104, a configuration input is received on the one or more map controls that filters out one or more filtered resources of a plurality of candidate resources to select a subset of one or more unfiltered resources. At block 106, the map is displayed in a filtered state showing at least a particular resource of the subset. At block 108, a selection is received of a particular task item of the one or more selectable task items while the map is in the filtered state. At block 110 the particular resource is automatically scheduled to complete the particular task item at a particular task location within a particular time constraint of the particular task item. Blocks 112-116 do not contain any dependencies and thus may be performed in any order or concurrently any time after block 110. At block 112, the particular status of the particular task item is automatically updated to indicate that the particular task item has been scheduled. At block 114, a resource task schedule for the particular resource is automatically updated to include a particular entry for the particular task item at a particular time. At block 116 the map is automatically updated to include a graphical indication that is based at least in part on both the particular task location and the particular resource location.

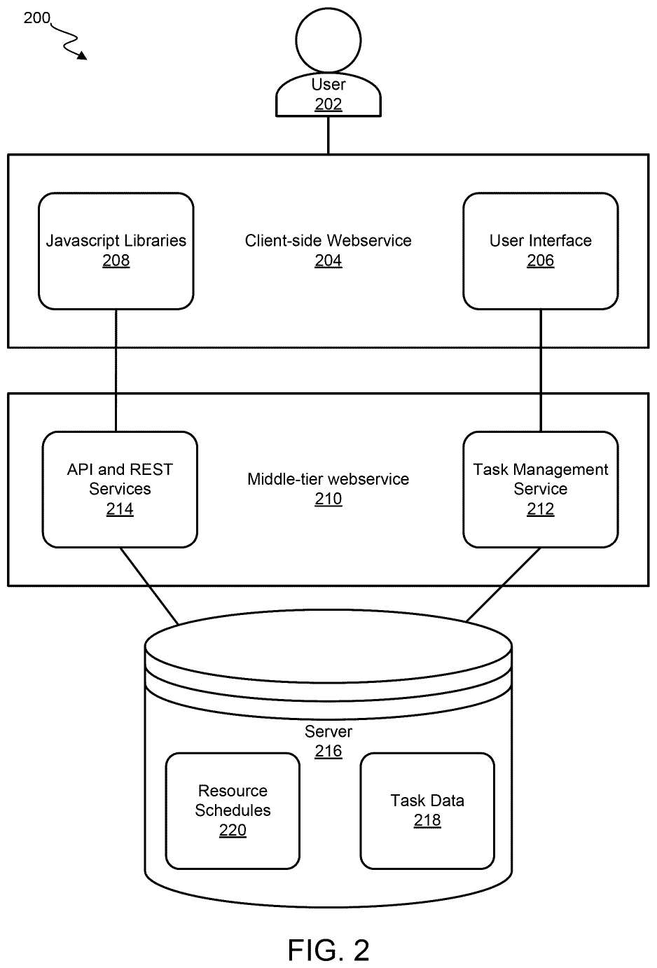

FIG. 2 depicts a distributed system 200 for implementing task and schedule management. A user 202 interacts with a client-side webservice 204 such as via a user interface 206. Requests via the user interface 206 or API calls from the user 202 may utilize JavaScript libraries 208 of the client-side webservice 204. The JavaScript libraries may initiate in a middle-tier webservice 210, one or more REST or other API calls from API and REST services 214. Requests for data via these services 214 may be performed on a server 216 containing task data 218 of received tasks and resources schedules 220 of existing schedules for resources. The information retrieved may be utilized by a task management service 212 to facilitate task scheduling. When a user inputs a command to assign a task to a selected resource in the user interface 206, the task management service 212 may initiate one or more API or REST calls to retrieve data of resource schedules and tasks from the server 216 to generate a suggested schedule for display on the user interface 206 with the selected task included in the selected resource's schedule.

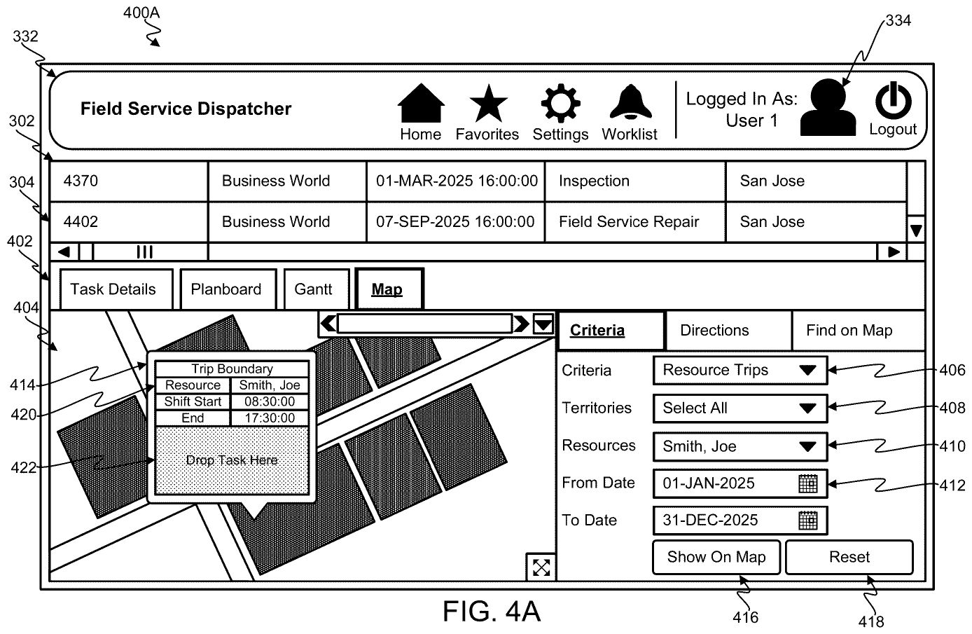

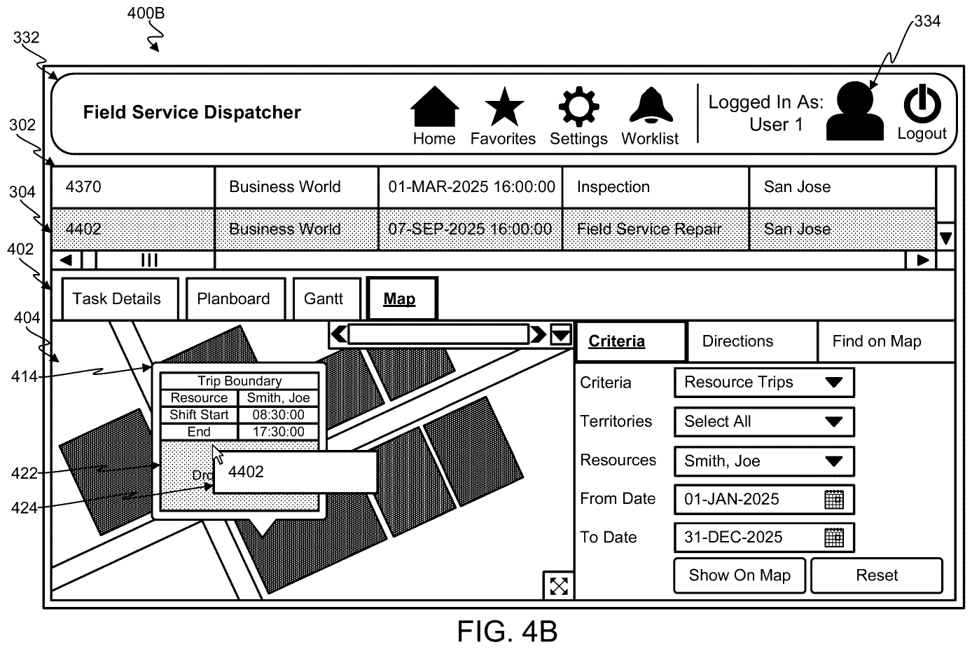

FIG. 4A depicts a user interface 400A for scheduling tasks in resource schedules. The user interface 400A includes a task region 302 and a map region 402. The map region 402 may include a map 404 number of selections 406-412 for filtering a map 404. The number of selections may include a criteria 406 for selecting the items to display on the map 404, a territory 408 to display on the map 404 and to filter the items displayed on the map, a selection of a resource 410 for selecting one or more resources to display on the map 404, and time-based settings 412 for selecting a time window to filter items to be displayed on the map 404. The map 404 may include a tooltip 414 displayed at the location of a currently selected resource from the number of selections 406-412. The tooltip may be displayed due to the selection of the resource such as in the resource selection option 410. The tooltip may also be displayed on the map 404 after adjusting a setting and selecting an option 416 for displaying the current selection on the map 404. The user interface may also include a reset option 418 for resetting the current selection of resources or settings to the default selections. The tooltip 414 may include a plurality of resource information 420 describing the selected resource. For example, the tooltip 414 includes a trip boundary, resource name, and shift start and end times. The tooltip 414 may also include a task selection region 422 for dragging selected tasks from the task region 302 to the task selection region 422 to select that task for scheduling.

FIG. 4B depicts a user interface 400B depicting the act of selecting a task for scheduling. The task 304 has been selected and depicts an indication of this selection via a changed color. The task 304 is being dragged to hover over the map region 402. The dragging function is indicated by a representation 424 of the task 304 under the cursor. The task, when dropped on the task selection region 422 is then scheduled for the selected resource.

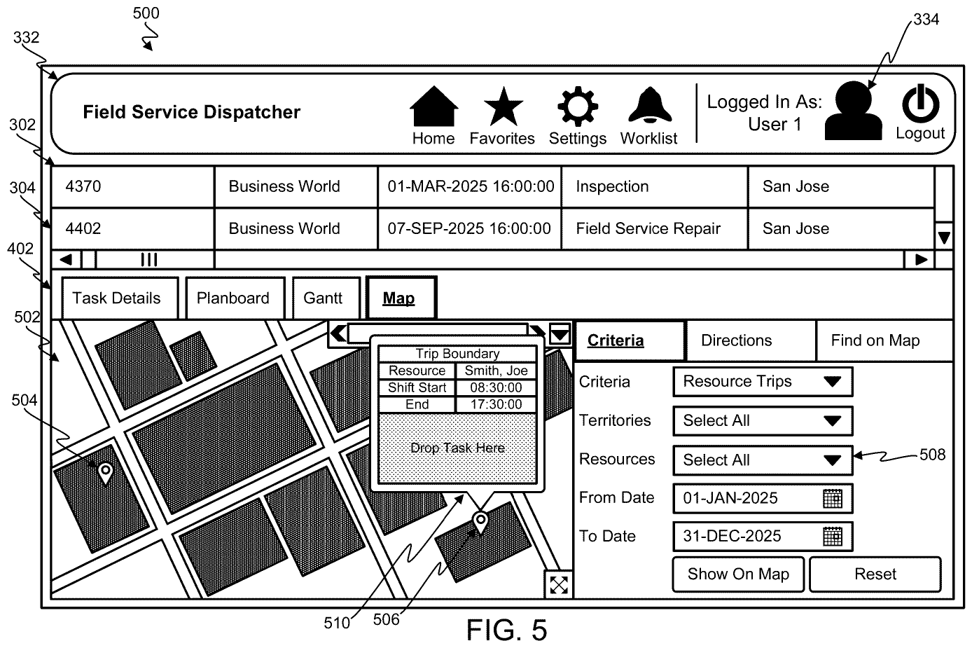

FIG. 5 depicts a user interface 500 where the map region 402 depicts multiple resources. The map region may contain a map 502 depicting one or more resource locations 504-506. The selection for resources to depict 508 is indicated to display all resources. The resources 504 and 506 are displayed concurrently on the map at their respective locations. The map region 402 may also display a tooltip 510 over one of the resources 504-506 based on a user selection, such as clicking on the resource location 506.

A criteria or display mode may be selected to show resource trips which configures the map region for displaying trips for a selected resource with a scheduled task at a task location different from the resource's current location. The resource trips criteria may also cause the display of a trip selection menu for selecting one of a plurality of trips which may be scheduled for a selected resource. The resource trips criteria may also cause the display of a directions region, which indicates calculated directions for one or more trips. The one or more trips with directions displayed in the directions region may be, for example, directions to and from a location for a task.

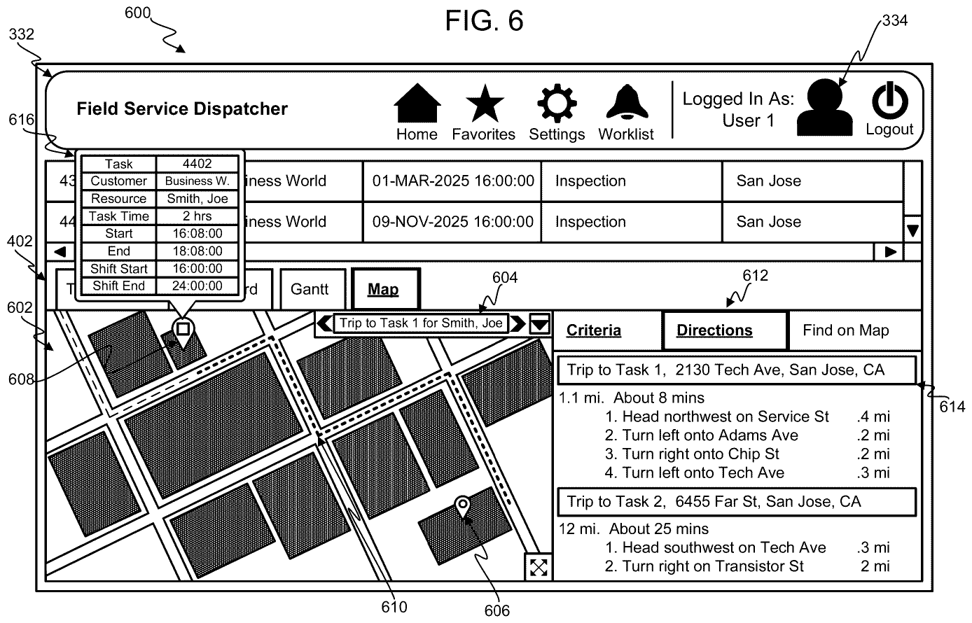

FIG. 6 depicts a user interface 600 depicting a map region 402 displaying a trip for a selected resource. The map region 402 displays a map 602 in a trip display mode selected by a trip selection 604. The trip selection indicates the trip to be for a particular resource, currently at the resource location 606. The particular resource has a scheduled task at a task location 608 and a trip 610 has automatically been generated between the resource location 606 and the task location 608. The trip 610 is a navigation path between the resource location 606 and the task location 608. The trip 610 may be part of a larger trip, indicated by a different representation on the map so as to indicate the trip 610 as the current component trip. A directions region 612 is selected to display a set of directions 614 describing the trip displayed on the map 602. A user may select another trip to display on the map 602 via the trip selection 604, in which case the map 602 and the directions 612 would be re-populated with the newly selected trip. The task location 608 may be selected to generate a tooltip 616 detailing information about the trip, task, or resource such that the resource name, shift start and end time, and the task start and end time.

A planboard region may be displayed. The planboard may display, for one or more resources of the set of resources, one or more plan blocks depicting events within the plan for that resource for a given day. Within the planboard, each plan block represents a single event. An event may be, for example, departure or arrival times in traveling between locations or an assigned task.

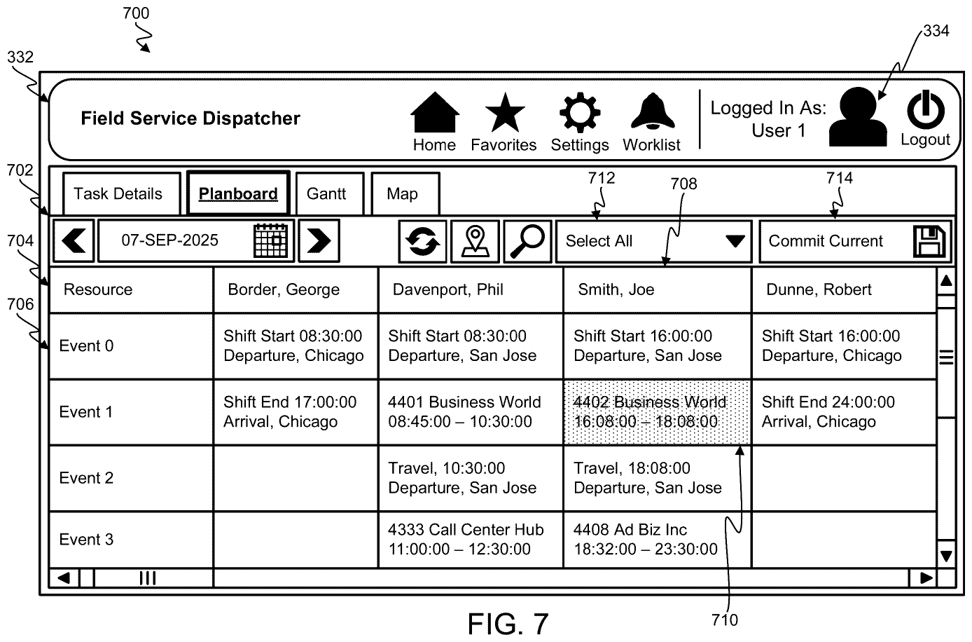

FIG. 7 depicts a user interface 700 with a planboard region 702. The planboard region 702 may include a number of resources 704 including the resource 708 each of which have a schedule including events 706. The resource 708 has a schedule including an event 710 for the scheduled, selected task. The user interface 700 may also include a setting 712 for filtering resources displayed. The user interface 700 may also include a selection 714 for committing current schedules of resources 704.

### Trip Planning

In one embodiment, to optimize a schedule, a trip is planned between each sequential location of the schedule to determine a schedule that minimizes travel time. Planning trips to different tasks for a resource's shift may be performed automatically when a trip view is generated for the resource's shift. Trip planning may also be performed when scheduling tasks in a resource's schedule in order to best order the tasks within the schedule. Even when tasks are assigned to a given day manually, a route planning algorithm may determine an order of tasks to perform based on the proximity of the next task from a previous location or to minimize travel time between task locations.

To plan a trip, a method of calculating distance is used to first determine a travel time required which is used in optimizing the schedule by sorting the tasks to minimize travel time. Tasks may be geocoded so as to easily pull location data for calculating distance measurements. After pulling location data for each of the tasks or start/end locations for a resource's schedule, the tasks may be sorted by first performing a distance measurement between each location to determine a path with the least travel time through the locations of the schedule. The path determined to have the least travel time, such as by finding a nearest neighbor, is used as the scheduled route for the resource's schedule and tasks are scheduled to be in the sorted order determined to minimize distance traveled. Distance measuring may be performed as-the-crow-flies or point-to-point by calculating a distance between the coordinates of two locations. This method may account for the curvature of the earth when considering large distances. Alternatively, route data may be pulled from a navigation database and used to calculate one or more candidate turn-by-turn routes to account for the roads and paths necessary to traverse to the destination. Calculating routes via navigation data is more accurate and can be made accurate to the exact time of the trip by factoring for traffic data, however, this method is slower than calculating a direct distance between the two coordinates. A fast method setting may be enabled to cause the distance calculation to use a coordinate calculation instead of a navigation calculation when it is necessary to save time.

After a trip is generated, the trip may be stored and displayed on the map region of the user interface. The user may select criteria for displaying trips of one or more selected resources for a selected time window, in which case the stored trips that fit the current selections or filters will be displayed on the map. When a trip is plotted on the map, the trip may be graphically indicated as a line between the two points that define the trip, or graphically indicated as a point associated with the trip. A user may select any location covered by the graphical indication to display a tooltip with additional information about the current trip.

The schedule management system may have a canvas user interface in which a user may define rules for automatically determining task assignment and trip parameters. The rules may factor for expected task length, average task performance time for a given resource, expertise level of a given resource, expertise level required for a given task. The set of rules defined by a user, when executed against the set of tasks and resource schedules as a combinatorial matrix is a “rules engine.” Rules may be configured for a given time period such that the user may define a total time in which to run the rules engine. As automatic assignment of tasks can be an NP hard problem, a window of time in which to run a rules engine will generate more efficiencies the longer the window is.

The set of rules may further include a rule for plan scope setting a total amount of time to prospect out for planning purposes such as a future number of days for generating a planned schedule. The set of rules may further include a rule for limiting the maximum travel time to a task within a territory. A bypass to this rule may be enabled such as for a contract with a client which may explicitly state that the client prefers to have certain parameters met, such as using a specific resource, and waives any limit to the travel time. The set of rules may further include a rule for maximum calculation time for setting a maximum time before cutting off the calculation and displaying results. For individual clients or resources, a rule may state that a given resource accepts time beyond the scope of their shift. The set of rules may further include a rule for toggling enforcing planned dates, where toggling off the selection allows the schedule management system to bypass limits such as enforcing start and end dates for scheduling tasks. The set of rules may further include a rule for spares requirements for enforcing parts requirements for tasks along with additional copies of the same part. The set of rules may further include a rule for same site tasks search horizon for setting a number of days forward to look to find other tasks to perform such that they may all be performed at the same time when on site. The set of rules may further include a rule for auto-committing same site tasks. The set of rules may further include a rule for setting a search radius in which to identify a same site. A client may define a time window in which to exclude service, such as during client business hours, in which case tasks will not be scheduled for times within the excluded time window. All rules may be defined broadly for a given client, for a whole organization, or individually for each territory or resource.

When performing schedule optimization, the schedule management system may perform task optimization, which determines a best resource for the selected task. Task optimization may be based on distance to travel to the task, skill and parts requirements, or other rules defined by a client. This may be used to automatically select a resource for a task or to suggest a resource to a user. The schedule management system may also perform cross-trip optimization, which compares the tasks assigned to a particular resource and determines a best schedule for the resource based at least in part on the calculated travel time between tasks. Cross-trip optimization may be performed for any tasks not yet committed at the time of performing the optimization. Cross-trip optimization may, in optimizing the scheduling of any non-committed task, consider information of any other task, including scheduled tasks, committed tasks, or tasks not scheduled at the time of performing the optimization. Performing automatic optimization of tasks that have been manually scheduled within the same day allows for greater optimization of trips and resource schedules while still permitting administrative users to maintain control or some level of human involvement.

The trip optimization algorithm may be used in suggesting a best resource when hovering a task over the map region. For example, a user may select a task and drag the task to the map region. The schedule management system may then perform a trip optimization for each of the resources available to determine a best resource for assigning the task based on filters of proximity throughout the resources' existing schedules, skill or parts requirements, or available time remaining in their schedules. The determined best resource or resources may be displayed to the user highlighted or a tooltip for suggested resources may be automatically displayed at the resource locations when hovering with the task. Resources listed as suggested resources for assigning a task may be ordered such as by a color coding to indicate the calculated order of suggestion. Suggested resources may also be displayed with one or more determined characteristics that support the suggestion of the resource as a best resource for assigning the task to. Identified characteristics of the suggested resource to display may include: a closest/furthest resource, a cheapest/most expensive resource, a busiest/least busy resource, a well-reviewed or not well-reviewed resource, a travel time required, a most/least eco-friendly resource or an eco-score such as a carbon footprint of the task for the resource, or a history of timeliness or average response time to get to or perform a task.

Alternatively, the schedule management system may utilize the suggested resources to automatically schedule a task for a resource. A suggested resource may automatically be used, without receiving manual input by a user selecting the particular resource if a setting permits automatic assignment of resources. A setting permitting automatic assignment of resource may be conditional such as only permitting automatic selection of a resource when a number of characteristics are true for a given resource. For example, a user may define a setting that permits automatic assignment of a resource under two conditions of characteristics for that resource: when that resource is a closest resource of all resources available, and when that resource is a cheapest resource of all available resources. A user may then confirm all automatic selections by either confirming a scheduling action after it is performed or by committing the task to the schedule.

### Computer System Architecture

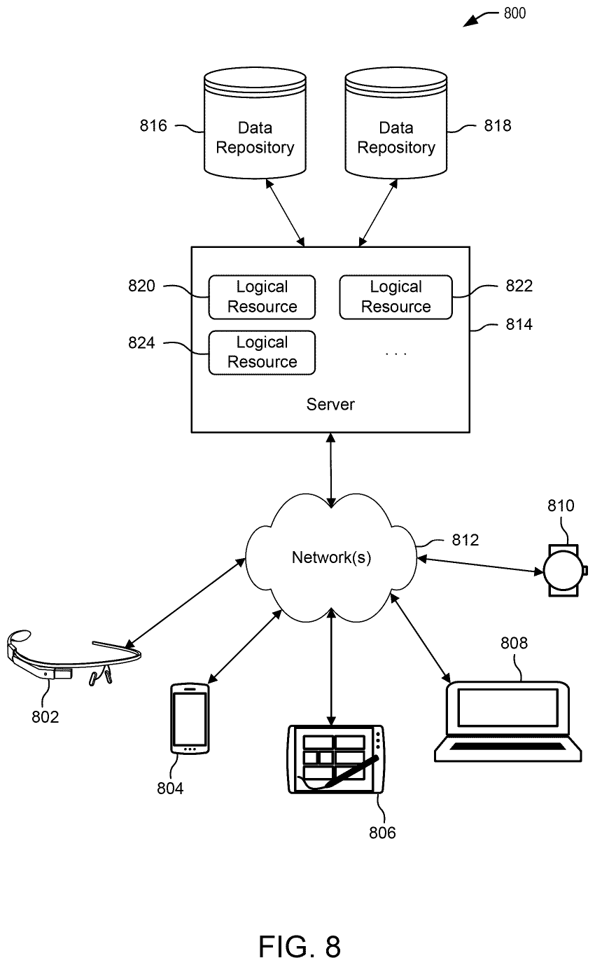

FIG. 8 depicts a simplified diagram of a distributed system 800 for implementing an embodiment. In the illustrated embodiment, distributed system 800 includes one or more client computing devices 802, 804, 806, 808, and/or 810 coupled to a server 814 via one or more communication networks 812. Clients computing devices 802, 804, 806, 808, and/or 810 may be configured to execute one or more applications.

In various aspects, server 814 may be adapted to run one or more services or software applications that enable techniques for task scheduling management.

In certain aspects, server 814 may also provide other services or software applications that can include non-virtual and virtual environments. In some aspects, these services may be offered as web-based or cloud services, such as under a Software as a Service (SaaS) model to the users of client computing devices 802, 804, 806, 808, and/or 810. Users operating client computing devices 802, 804, 806, 808, and/or 810 may in turn utilize one or more client applications to interact with server 814 to utilize the services provided by these components.

In the configuration depicted in FIG. 8, server 814 may include one or more components 820, 822 and 824 that implement the functions performed by server 814. These components may include software components that may be executed by one or more processors, hardware components, or combinations thereof. It should be appreciated that various different system configurations are possible, which may be different from distributed system 800. The embodiment shown in FIG. 8 is thus one example of a distributed system for implementing an embodiment system and is not intended to be limiting.

Users may use client computing devices 802, 804, 806, 808, and/or 810 for techniques for task scheduling management in accordance with the teachings of this disclosure. A client device may provide an interface that enables a user of the client device to interact with the client device. The client device may also output information to the user via this interface. Although FIG. 8 depicts only five client computing devices, any number of client computing devices may be supported.

The client devices may include various types of computing systems such as smart phones or other portable handheld devices, general purpose computers such as personal computers and laptops, workstation computers, personal assistant devices, smart watches, smart glasses, or other wearable devices, equipment firmware, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux® or Linux-like operating systems such as Oracle® Linux and Google Chrome® OS) including various mobile operating systems (e.g., Microsoft Windows Mobile®, iOS®, Windows Phone®, Android®, HarmonyOS®, Tizen®, KaiOS®, Sailfish® OS, Ubuntu® Touch, CalyxOS®). Portable handheld devices may include cellular phones, smartphones, (e.g., an iPhone®), tablets (e.g., iPad®), and the like. Virtual personal assistants such as Amazon® Alexa®, Google® Assistant, Microsoft® Cortana®, Apple® Siri®, and others may be implemented on devices with a microphone and/or camera to receive user or environmental inputs, as well as a speaker and/or display to respond to the inputs. Wearable devices may include Apple® Watch, Samsung Galaxy® Watch, Meta Quest®, Ray-Ban® Meta® smart glasses, Snap® Spectacles, and other devices. Gaming systems may include various handheld gaming devices, Internet-enabled gaming devices (e.g., a Microsoft Xbox® gaming console with or without a Kinect® gesture input device, Sony PlayStation® system, Nintendo Switch®, and other devices), and the like. The client devices may be capable of executing various different applications such as various Internet-related apps, communication applications (e.g., e-mail applications, short message service (SMS) applications) and may use various communication protocols.

Network(s) 812 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 812 can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth®, and/or any other wireless protocol), and/or any combination of these and/or other networks.

Server 814 may be composed of one or more general purpose computers, specialized server computers (including, by way of example, PC (personal computer) servers, UNIX® servers, LINIX® servers, mid-range servers, mainframe computers, rack-mounted servers, etc.), server farms, server clusters, a Real Application Cluster (RAC), database servers, or any other appropriate arrangement and/or combination. Server 814 can include one or more virtual machines running virtual operating systems, or other computing architectures involving virtualization such as one or more flexible pools of logical storage devices that can be virtualized to maintain virtual storage devices for the server. In various aspects, server 814 may be adapted to run one or more services or software applications that provide the functionality described in the foregoing disclosure.

The computing systems in server 814 may run one or more operating systems including any of those discussed above, as well as any commercially available server operating system. Server 814 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, SAP®, Amazon®, Sybase®, IBM® (International Business Machines), and the like.

In some implementations, server 814 may include one or more applications to analyze and consolidate data feeds and/or event updates received from users of client computing devices 802, 804, 806, 808, and/or 810. As an example, data feeds and/or event updates may include, but are not limited to, blog feeds, Threads® feeds, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 814 may also include one or more applications to display the data feeds and/or real-time events via one or more display devices of client computing devices 802, 804, 806, 808, and/or 810.

Distributed system 800 may also include one or more data repositories 816, 818. These data repositories may be used to store data and other information in certain aspects. For example, one or more of the data repositories 816, 818 may be used to store information for techniques for task scheduling management. Data repositories 816, 818 may reside in a variety of locations. For example, a data repository used by server 814 may be local to server 814 or may be remote from server 814 and in communication with server 814 via a network-based or dedicated connection. Data repositories 816, 818 may be of different types. In certain aspects, a data repository used by server 814 may be a database, for example, a relational database, a container database, an Exadata® storage device, or other data storage and retrieval tool such as databases provided by Oracle Corporation® and other vendors. One or more of these databases may be adapted to enable storage, update, and retrieval of data to and from the database in response to structured query language (SQL)-formatted commands.

In certain aspects, one or more of data repositories 816, 818 may also be used by applications to store application data. The data repositories used by applications may be of different types such as, for example, a key-value store repository, an object store repository, or a general storage repository supported by a file system.

In one embodiment, server 814 is part of a cloud-based system environment in which various services may be offered as cloud services, for a single tenant or for multiple tenants where data, requests, and other information specific to the tenant are kept private from each tenant. In the cloud-based system environment, multiple servers may communicate with each other to perform the work requested by client devices from the same or multiple tenants. The servers communicate on a cloud-side network that is not accessible to the client devices in order to perform the requested services and keep tenant data confidential from other tenants.

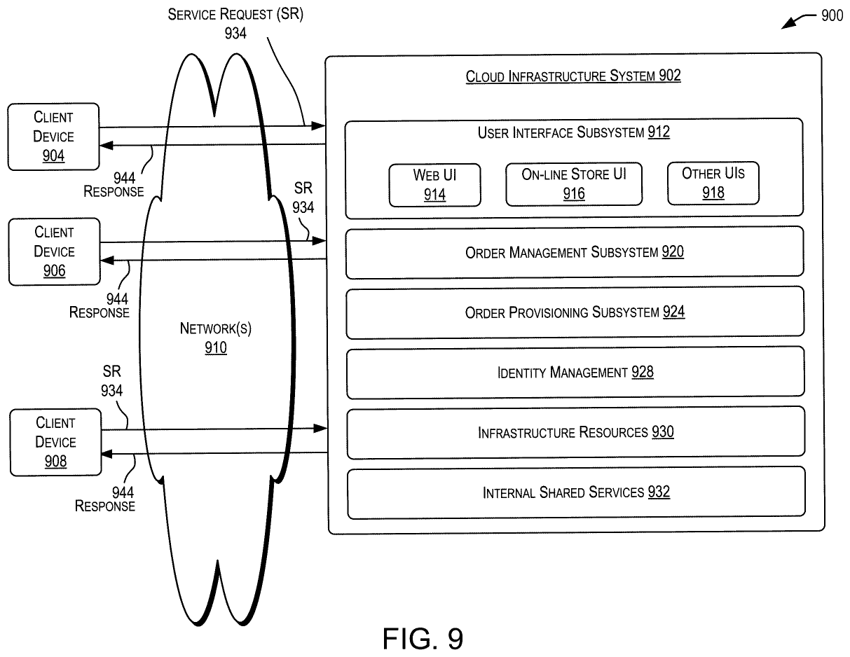

FIG. 9 is a simplified block diagram of a cloud-based system environment in which task scheduling management, in accordance with certain aspects, is performed. In the embodiment depicted in FIG. 9, cloud infrastructure system 902 may provide one or more cloud services that may be requested by users using one or more client computing devices 904, 906, and 908. Cloud infrastructure system 902 may comprise one or more computers and/or servers that may include those described above for server 814. The computers in cloud infrastructure system 902 may be organized as general purpose computers, specialized server computers, server farms, server clusters, or any other appropriate arrangement and/or combination.

Network(s) 910 may facilitate communication and exchange of data between clients 904, 906, and 908 and cloud infrastructure system 902. Network(s) 910 may include one or more networks. The networks may be of the same or different types. Network(s) 910 may support one or more communication protocols, including wired and/or wireless protocols, for facilitating the communications.

The embodiment depicted in FIG. 9 is only one example of a cloud infrastructure system and is not intended to be limiting. It should be appreciated that, in some other aspects, cloud infrastructure system 902 may have more or fewer components than those depicted in FIG. 9, may combine two or more components, or may have a different configuration or arrangement of components. For example, although FIG. 9 depicts three client computing devices, any number of client computing devices may be supported in alternative aspects.

The term cloud service is generally used to refer to a service that is made available to users on demand and via a communication network such as the Internet by systems (e.g., cloud infrastructure system 902) of a service provider. Typically, in a public cloud environment, servers and systems that make up the cloud service provider's system are different from the cloud customer's (“tenant's”) own on-premise servers and systems. The cloud service provider's systems are managed by the cloud service provider. Tenants can thus avail themselves of cloud services provided by a cloud service provider without having to purchase separate licenses, support, or hardware and software resources for the services. For example, a cloud service provider's system may host an application, and a user may, via a network 910 (e.g., the Internet), on demand, order and use the application without the user having to buy infrastructure resources for executing the application. Cloud services are designed to provide easy, scalable access to applications, resources, and services. Several providers offer cloud services. For example, several cloud services are offered by Oracle Corporation®, such as database services, middleware services, application services, and others.

In certain aspects, cloud infrastructure system 902 may provide one or more cloud services using different models such as under a Software as a Service (SaaS) model, a Platform as a Service (PaaS) model, an Infrastructure as a Service (IaaS) model, a Data as a Service (DaaS) model, and others, including hybrid service models. Cloud infrastructure system 902 may include a suite of databases, middleware, applications, and/or other resources that enable provision of the various cloud services.

A SaaS model enables an application or software to be delivered to a tenant's client device over a communication network like the Internet, as a service, without the tenant having to buy the hardware or software for the underlying application. For example, a SaaS model may be used to provide tenants access to on-demand applications that are hosted by cloud infrastructure system 902. Examples of SaaS services provided by Oracle Corporation® include, without limitation, various services for human resources/capital management, client relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware, and networking resources) to a tenant as a cloud service to provide elastic compute and storage capabilities. Various IaaS services are provided by Oracle Corporation®.

A PaaS model is generally used to provide, as a service, platform and environment resources that enable tenants to develop, run, and manage applications and services without the tenant having to procure, build, or maintain such resources. Examples of PaaS services provided by Oracle Corporation® include, without limitation, Oracle Database Cloud Service (DBCS), Oracle Java Cloud Service (JCS), data management cloud service, various application development solutions services, and others.

A DaaS model is generally used to provide data as a service. Datasets may searched, combined, summarized, and downloaded or placed into use between applications. For example, user profile data may be updated by one application and provided to another application. As another example, summaries of user profile information generated based on a dataset may be used to enrich another dataset.

Cloud services are generally provided on an on-demand self-service basis, subscription-based, elastically scalable, reliable, highly available, and secure manner. For example, a tenant, via a subscription order, may order one or more services provided by cloud infrastructure system 902. Cloud infrastructure system 902 then performs processing to provide the services requested in the tenant's subscription order. Cloud infrastructure system 902 may be configured to provide one or even multiple cloud services.

Cloud infrastructure system 902 may provide the cloud services via different deployment models. In a public cloud model, cloud infrastructure system 902 may be owned by a third party cloud services provider and the cloud services are offered to any general public tenant, where the tenant can be an individual or an enterprise. In certain other aspects, under a private cloud model, cloud infrastructure system 902 may be operated within an organization (e.g., within an enterprise organization) and services provided to clients that are within the organization. For example, the clients may be various departments or employees or other individuals of departments of an enterprise such as the Human Resources department, the Payroll department, etc., or other individuals of the enterprise. In certain other aspects, under a community cloud model, the cloud infrastructure system 902 and the services provided may be shared by several organizations in a related community. Various other models such as hybrids of the above mentioned models may also be used.

Client computing devices 904, 906, and 908 may be of different types (such as devices 802, 804, 806, and 808 depicted in FIG. 8) and may be capable of operating one or more client applications. A user may use a client device to interact with cloud infrastructure system 902, such as to request a service provided by cloud infrastructure system 902.

In some aspects, the processing performed by cloud infrastructure system 902 for providing chatbot services may involve big data analysis. This analysis may involve using, analyzing, and manipulating large data sets to detect and visualize various trends, behaviors, relationships, etc. within the data. This analysis may be performed by one or more processors, possibly processing the data in parallel, performing simulations using the data, and the like. For example, big data analysis may be performed by cloud infrastructure system 902 for determining the intent of an utterance. The data used for this analysis may include structured data (e.g., data stored in a database or structured according to a structured model) and/or unstructured data (e.g., data blobs (binary large objects)).

As depicted in the embodiment in FIG. 9, cloud infrastructure system 902 may include infrastructure resources 930 that are utilized for facilitating the provision of various cloud services offered by cloud infrastructure system 902. Infrastructure resources 930 may include, for example, processing resources, storage or memory resources, networking resources, and the like.

In certain aspects, to facilitate efficient provisioning of these resources for supporting the various cloud services provided by cloud infrastructure system 902 for different tenants, the resources may be bundled into sets of resources or resource modules (also referred to as “pods”). Each resource module or pod may comprise a pre-integrated and optimized combination of resources of one or more types. In certain aspects, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 902 may itself internally use services 932 that are shared by different components of cloud infrastructure system 902 and which facilitate the provisioning of services by cloud infrastructure system 902. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like.

Cloud infrastructure system 902 may comprise multiple subsystems. These subsystems may be implemented in software, or hardware, or combinations thereof. As depicted in FIG. 9, the subsystems may include a user interface subsystem 912 that enables users of cloud infrastructure system 902 to interact with cloud infrastructure system 902. User interface subsystem 912 may include various different interfaces such as a web interface 914, an online store interface 916 where cloud services provided by cloud infrastructure system 902 are advertised and are purchasable by a consumer, and other interfaces 918. For example, a tenant may, using a client device, request (service request 934) one or more services provided by cloud infrastructure system 902 using one or more of interfaces 914, 916, and 918. For example, a tenant may access the online store, browse cloud services offered by cloud infrastructure system 902, and place a subscription order for one or more services offered by cloud infrastructure system 902 that the tenant wishes to subscribe to. The service request may include information identifying the tenant and one or more services that the tenant desires to subscribe to. For example, a tenant may place a subscription order for a chatbot related service offered by cloud infrastructure system 902. As part of the order, the client may provide information identifying the input (e.g. utterances).

In certain aspects, such as the embodiment depicted in FIG. 9, cloud infrastructure system 902 may comprise an order management subsystem (OMS) 920 that is configured to process the new order. As part of this processing, OMS 920 may be configured to: create an account for the tenant, if not done already; receive billing and/or accounting information from the tenant that is to be used for billing the tenant for providing the requested service to the tenant; verify the tenant information; upon verification, book the order for the tenant; and orchestrate various workflows to prepare the order for provisioning.

Once properly validated, OMS 920 may then invoke the order provisioning subsystem (OPS) 924 that is configured to provision resources for the order including processing, memory, and networking resources. The provisioning may include allocating resources for the order and configuring the resources to facilitate the service requested by the tenant order. The manner in which resources are provisioned for an order and the type of the provisioned resources may depend upon the type of cloud service that has been ordered by the tenant. For example, according to one workflow, OPS 924 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting tenant for providing the requested service.

Cloud infrastructure system 902 may send a response or notification 944 to the requesting tenant to indicate when the requested service is now ready for use. In some instances, information (e.g., a link) may be sent to the tenant that enables the tenant to start using and availing the benefits of the requested services.

Cloud infrastructure system 902 may provide services to multiple tenants. For each tenant, cloud infrastructure system 902 is responsible for managing information related to one or more subscription orders received from the tenant, maintaining tenant data related to the orders, and providing the requested services to the tenant or clients of the tenant. Cloud infrastructure system 902 may also collect usage statistics regarding a tenant's use of subscribed services. For example, statistics may be collected for the amount of storage used, the amount of data transferred, the number of users, and the amount of system up time and system down time, and the like. This usage information may be used to bill the tenant. Billing may be done, for example, on a monthly cycle.

Cloud infrastructure system 902 may provide services to multiple tenants in parallel. Cloud infrastructure system 902 may store information for these tenants, including possibly proprietary information. In certain aspects, cloud infrastructure system 902 comprises an identity management subsystem (IMS) 928 that is configured to manage tenant's information and provide the separation of the managed information such that information related to one tenant is not accessible by another tenant. IMS 928 may be configured to provide various security-related services such as identity services, such as information access management, authentication and authorization services, services for managing tenant identities and roles and related capabilities, and the like.

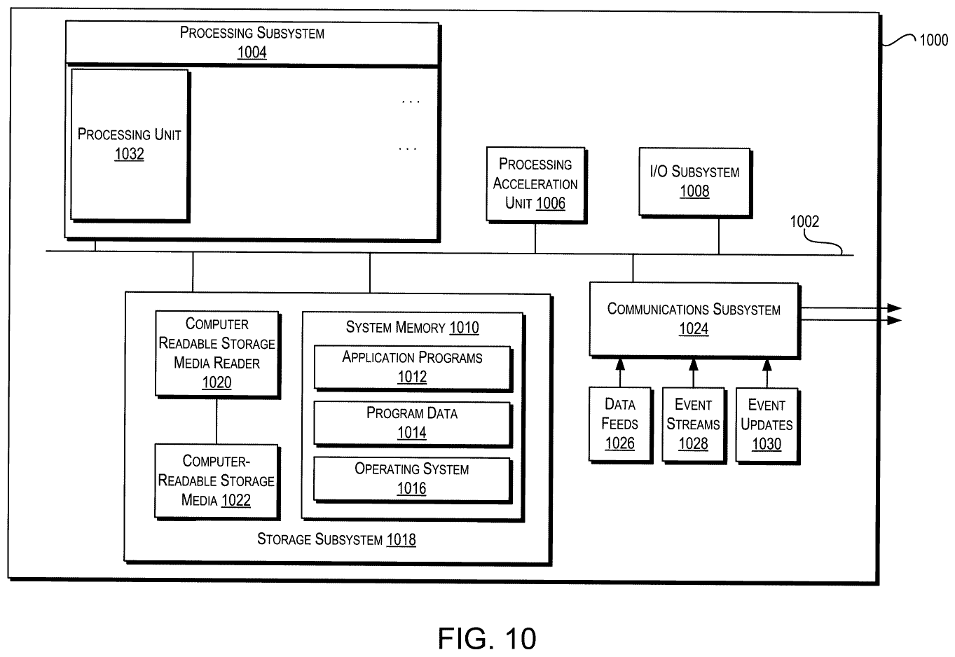

FIG. 10 illustrates an exemplary computer system 1000 that may be used to implement certain aspects. As shown in FIG. 10, computer system 1000 includes various subsystems including a processing subsystem 1004 that communicates with a number of other subsystems via a bus subsystem 1002. These other subsystems may include a processing acceleration unit 1006, an I/O subsystem 1008, a storage subsystem 1018, and a communications subsystem 1024. Storage subsystem 1018 may include non-transitory computer-readable storage media including storage media 1022 and a system memory 1010.

Bus subsystem 1002 provides a mechanism for letting the various components and subsystems of computer system 1000 communicate with each other as intended. Although bus subsystem 1002 is shown schematically as a single bus, alternative aspects of the bus subsystem may utilize multiple buses. Bus subsystem 1002 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 1004 controls the operation of computer system 1000 and may comprise one or more processors, application specific integrated circuits (ASICs), or field programmable gate arrays (FPGAs). The processors may be single core or multicore processors. The processing resources of computer system 1000 can be organized into one or more processing units 1032, 1034, etc. A processing unit may include one or more processors, one or more cores from the same or different processors, a combination of cores and processors, or other combinations of cores and processors. In some aspects, processing subsystem 1004 can include one or more special purpose co-processors such as graphics processors, digital signal processors (DSPs), or the like. In some aspects, some or all of the processing units of processing subsystem 1004 can be implemented using customized circuits, such as application specific integrated circuits (ASICs), or field programmable gate arrays (FPGAs).

In some aspects, the processing units in processing subsystem 1004 can execute instructions stored in system memory 1010 or on computer readable storage media 1022. In various aspects, the processing units can execute a variety of programs or code instructions and can maintain multiple concurrently executing programs or processes. At any given time, some or all of the program code to be executed can be resident in system memory 1010 and/or on computer-readable storage media 1022 including potentially on one or more storage devices. Through suitable programming, processing subsystem 1004 can provide various functionalities described above. In instances where computer system 1000 is executing one or more virtual machines, one or more processing units may be allocated to each virtual machine.

In certain aspects, a processing acceleration unit 1006 may optionally be provided for performing customized processing or for off-loading some of the processing performed by processing subsystem 1004 so as to accelerate the overall processing performed by computer system 1000.

I/O subsystem 1008 may include devices and mechanisms for inputting information to computer system 1000 and/or for outputting information from or via computer system 1000. In general, use of the term input device is intended to include all possible types of devices and mechanisms for inputting information to computer system 1000. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Meta Quest® controller, Microsoft Kinect® motion sensor, the Microsoft Xbox® 360 game controller, or devices that provide an interface for receiving input using gestures and spoken commands. User interface input devices may also include eye gesture recognition devices such as a blink detector that detects eye activity (e.g., “blinking” while taking pictures and/or making a menu selection) from users and transforms the eye gestures as inputs to an input device. Additionally, user interface input devices may include voice recognition sensing devices that enable users to interact with voice recognition systems (e.g., Siri® navigator or Amazon Alexa®) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, QR code readers, barcode readers, 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

In general, use of the term output device is intended to include all possible types of devices and mechanisms for outputting information from computer system 1000 to a user or other computer. User interface output devices may include a display subsystem, indicator lights, or non-visual displays such as audio output devices, etc. The display subsystem may be any device for outputting a digital picture. Example display devices include flat panel display devices such as those using a light emitting diode (LED) display, a liquid crystal display (LCD) or plasma display, a projection device, a touch screen, a desktop or laptop computer monitor, and the like. As another example, wearable display devices such as Meta Quest® or Microsoft HoloLens® may be mounted to the user for displaying information. User interface output devices may include, without limitation, a variety of display devices that visually convey text, graphics, and audio/video information such as monitors, printers, speakers, headphones, automotive navigation systems, plotters, voice output devices, and modems.

Storage subsystem 1018 provides a repository or data store for storing information and data that is used by computer system 1000. Storage subsystem 1018 provides a tangible non-transitory computer-readable storage medium for storing the basic programming and data constructs that provide the functionality of some aspects. Storage subsystem 1018 may store software (e.g., programs, code modules, instructions) that when executed by processing subsystem 1004 provides the functionality described above. The software may be executed by one or more processing units of processing subsystem 1004. Storage subsystem 1018 may also provide a repository for storing data used in accordance with the teachings of this disclosure.

Storage subsystem 1018 may include one or more non-transitory memory devices, including volatile and non-volatile memory devices. As shown in FIG. 10, storage subsystem 1018 includes a system memory 1010 and a computer-readable storage media 1022. System memory 1010 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 1000, such as during start-up, may typically be stored in the ROM. The RAM typically contains data and/or program modules that are presently being operated and executed by processing subsystem 1004. In some implementations, system memory 1010 may include multiple different types of memory, such as static random access memory (SRAM), dynamic random access memory (DRAM), and the like.

By way of example, and not limitation, as depicted in FIG. 10, system memory 1010 may load application programs 1012 that are being executed, which may include various applications such as Web browsers, mid-tier applications, relational database management systems (RDBMS), etc., program data 1014, and an operating system 1016. By way of example, operating system 1016 may include various versions of Microsoft Windows®, Apple Macintosh®, and/or Linux® operating systems, a variety of commercially-available UNIX® or UNIX-like operating systems (including without limitation the variety of GNU/Linux operating systems, the Oracle Linux®, Google Chrome® OS, and the like) and/or mobile operating systems such as iOS, Windows® Phone, Android® OS, and others.

Computer-readable storage media 1022 may store programming and data constructs that provide the functionality of some aspects. Computer-readable media 1022 may provide storage of computer-readable instructions, data structures, program modules, and other data for computer system 1000. Software (programs, code modules, instructions) that, when executed by processing subsystem 1004 provides the functionality described above, may be stored in storage subsystem 1018. By way of example, computer-readable storage media 1022 may include non-volatile memory such as a hard disk drive, a magnetic disk drive, an optical disk drive such as a CD ROM, digital video disc (DVD), a Blu-Ray® disk, or other optical media. Computer-readable storage media 1022 may include, but is not limited to, Zip® drives, flash memory cards, universal serial bus (USB) flash drives, secure digital (SD) cards, DVD disks, digital video tape, and the like. Computer-readable storage media 1022 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, dynamic random access memory (DRAM)-based SSDs, magnetoresistive RAM (MRAM) SSDs, and hybrid SSDs that use a combination of DRAM and flash memory based SSDs.

In certain aspects, storage subsystem 1018 may also include a computer-readable storage media reader 1020 that can further be connected to computer-readable storage media 1022. Reader 1020 may receive and be configured to read data from a memory device such as a disk, a flash drive, etc.

In certain aspects, computer system 1000 may support virtualization technologies, including but not limited to virtualization of processing and memory resources. For example, computer system 1000 may provide support for executing one or more virtual machines. In certain aspects, computer system 1000 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 1000. Accordingly, multiple operating systems may potentially be run concurrently by computer system 1000.

Communications subsystem 1024 provides an interface to other computer systems and networks. Communications subsystem 1024 serves as an interface for receiving data from and transmitting data to other systems from computer system 1000. For example, communications subsystem 1024 may enable computer system 1000 to establish a communication channel to one or more client devices via the Internet for receiving and sending information from and to the client devices. For example, the communications subsystem may be used to transmit a response to a user regarding the inquiry for a chatbot.

Communications subsystem 1024 may support both wired and/or wireless communication protocols. For example, in certain aspects, communications subsystem 1024 may include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 802.XX family standards, or other mobile communication technologies, or any combination thereof), global positioning system (GPS) receiver components, and/or other components. In some aspects communications subsystem 1024 can provide wired network connectivity (e.g., Ethernet) in addition to or instead of a wireless interface.

Communications subsystem 1024 can receive and transmit data in various forms. For example, in some aspects, in addition to other forms, communications subsystem 1024 may receive input communications in the form of structured and/or unstructured data feeds 1026, event streams 1028, event updates 1030, and the like. For example, communications subsystem 1024 may be configured to receive (or send) data feeds 1026 in real-time from users of social media networks and/or other communication services such as Twitter® feeds, Facebook® updates, web feeds such as Rich Site Summary (RSS) feeds, and/or real-time updates from one or more third party information sources.

In certain aspects, communications subsystem 1024 may be configured to receive data in the form of continuous data streams, which may include event streams 1028 of real-time events and/or event updates 1030, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1024 may also be configured to communicate data from computer system 1000 to other computer systems or networks. The data may be communicated in various different forms such as structured and/or unstructured data feeds 1026, event streams 1028, event updates 1030, and the like to one or more databases that may be in communication with one or more streaming data source computers coupled to computer system 1000.

Computer system 1000 can be one of various types, including a handheld portable device (e.g., an iPhone® cellular phone, an iPad® computing tablet, a personal digital assistant (PDA)), a wearable device (e.g., a Meta Quest® head mounted display), a personal computer, a workstation, a mainframe, a kiosk, a server rack, or any other data processing system. Due to the ever-changing nature of computers and networks, the description of computer system 1000 depicted in FIG. 10 is intended only as a specific example. Many other configurations having more or fewer components than the system depicted in FIG. 10 are possible. Based on the disclosure and teachings provided herein, a person of ordinary skill in the art can appreciate other ways and/or methods to implement the various aspects.

Although specific aspects have been described, various modifications, alterations, alternative constructions, and equivalents are possible. Embodiments are not restricted to operation within certain specific data processing environments, but are free to operate within a plurality of data processing environments. Additionally, although certain aspects have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described aspects may be used individually or jointly.

Further, while certain aspects have been described using a particular combination of hardware and software, it should be recognized that other combinations of hardware and software are also possible. Certain aspects may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the aspects. However, aspects may be practiced without these specific details. For example, well-known circuits, processes, algorithms, structures, and techniques have been shown without unnecessary detail in order to avoid obscuring the aspects. This description provides example aspects only, and is not intended to limit the scope, applicability, or configuration of other aspects. Rather, the preceding description of the aspects can provide those skilled in the art with an enabling description for implementing various aspects. Various changes may be made in the function and arrangement of elements.

The specification and drawings are, accordingly, to be regarded in an illustrative rather than a restrictive sense. It can, however, be evident that additions, subtractions, deletions, and other modifications and changes may be made thereunto without departing from the broader spirit and scope as set forth in the claims. Thus, although specific aspects have been described, these are not intended to be limiting. Various modifications and equivalents are within the scope of the following claims.

What is claimed is:

1. A computer-implemented method comprising:
causing display of a map, one or more map controls, and one or more selectable task items;
receiving configuration input to the one or more map controls, wherein the configuration input filters out one or more filtered resources of a plurality of candidate resources to select a subset of one or more unfiltered resources of the plurality of candidate resources;
causing display of the map in a filtered state, wherein the filtered state of the map shows at least a particular resource of the subset at a particular resource location associated with the particular resource without showing the one or more filtered resources on the map;
while the map is in the filtered state, receiving a selection of a particular task item of the one or more selectable task items;
based at least in part on the selection of the particular task item:
automatically scheduling the particular resource to complete the particular task item at a particular task location associated with the particular task item within a particular time constraint of the particular task item;
automatically updating a particular status of the particular task item to indicate that the particular task item has been scheduled;
automatically updating a resource task schedule for the particular resource to include a particular entry for the particular task item at a particular time; wherein the updated resource task schedule also includes one or more other entries for one or more other task items scheduled at one or more other times;
automatically updating the map to include a graphical indication that is based at least in part on both the particular task location and the particular resource location.

2. The computer-implemented method of claim 1, wherein the graphical indication comprises one or more graphically displayed routes between the particular resource location and the particular task location.

3. The computer-implemented method of claim 1, wherein the graphical indication comprises a graphical marking that covers both the particular resource location and the particular task location.

4. The computer-implemented method of claim 1, wherein the graphical indication comprises metadata that is based on one or more metrics predicted for a trip between the particular resource location and the particular task location.

5. The computer-implemented method of claim 1, further comprising:
based at least in part on the selection of the particular task item, automatically adding one or more notification conditions to the particular entry based at least in part on a notification setting for an entity associated with the particular task item;
determining whether the one or more notification conditions have been satisfied, and, in response to determining that the one or more notification conditions have been satisfied, triggering a notification to the entity.

6. The computer-implemented method of claim 1, wherein receiving the selection of the particular task item of the one or more selectable task items comprises receiving input that drags the particular task item from a task item region of a user interface to the map; wherein the map is in a map region of the user interface.

7. The computer-implemented method of claim 1, wherein receiving the selection of the particular task item of the one or more selectable task items comprises receiving a selection of the particular resource among two or more displayed resources of the subset.

8. The computer-implemented method of claim 7, wherein the two or more displayed resources of the subset are displayed in an order sorted based at least in part on one or more characteristics of each of the two or more displayed resources in comparison with one or more corresponding characteristics of the particular task item.

9. The computer-implemented method of claim 7, further comprising causing display of graphical indications of two or more characteristics of each of the two or more displayed resources to support receiving the selection of the particular resource.

10. The computer-implemented method of claim 1, further comprising:
in response to the selection of the particular task item, without receiving manual input selecting the particular resource from among two or more resources of the subset, automatically selecting the particular resource based at least in part on one or more characteristics of each of the two or more resources in comparison with one or more corresponding characteristics of the particular task item.

11. A computer-program product comprising one or more non-transitory machine-readable storage media, including stored instructions configured to cause a computing system to perform a set of actions including:
causing display of a map, one or more map controls, and one or more selectable task items;
receiving configuration input to the one or more map controls, wherein the configuration input filters out one or more filtered resources of a plurality of candidate resources to select a subset of one or more unfiltered resources of the plurality of candidate resources;
causing display of the map in a filtered state, wherein the filtered state of the map shows at least a particular resource of the subset at a particular resource location associated with the particular resource without showing the one or more filtered resources on the map;
while the map is in the filtered state, receiving a selection of a particular task item of the one or more selectable task items;
based at least in part on the selection of the particular task item:
automatically scheduling the particular resource to complete the particular task item at a particular task location associated with the particular task item within a particular time constraint of the particular task item;
automatically updating a particular status of the particular task item to indicate that the particular task item has been scheduled;
automatically updating a resource task schedule for the particular resource to include a particular entry for the particular task item at a particular time; wherein the updated resource task schedule also includes one or more other entries for one or more other task items scheduled at one or more other times;
automatically updating the map to include a graphical indication that is based at least in part on both the particular task location and the particular resource location.

12. The computer-program product of claim 11, wherein the graphical indication comprises one or more graphically displayed routes between the particular resource location and the particular task location.

13. The computer-program product of claim 11, wherein the graphical indication comprises metadata that is based on one or more metrics predicted for a trip between the particular resource location and the particular task location.

14. The computer-program product of claim 11, wherein receiving the selection of the particular task item of the one or more selectable task items comprises receiving input that drags the particular task item from a task item region of a user interface to the map; wherein the map is in a map region of the user interface.

15. The computer-program product of claim 11, wherein receiving the selection of the particular task item of the one or more selectable task items comprises receiving a selection of the particular resource among two or more displayed resources of the subset.

16. A system comprising:
one or more processors;
one or more non-transitory computer-readable media storing instructions, which, when executed by the system, cause the system to perform a set of actions including:
causing display of a map, one or more map controls, and one or more selectable task items;
receiving configuration input to the one or more map controls, wherein the configuration input filters out one or more filtered resources of a plurality of candidate resources to select a subset of one or more unfiltered resources of the plurality of candidate resources;
causing display of the map in a filtered state, wherein the filtered state of the map shows at least a particular resource of the subset at a particular resource location associated with the particular resource without showing the one or more filtered resources on the map;
while the map is in the filtered state, receiving a selection of a particular task item of the one or more selectable task items;
based at least in part on the selection of the particular task item:
automatically scheduling the particular resource to complete the particular task item at a particular task location associated with the particular task item within a particular time constraint of the particular task item;
automatically updating a particular status of the particular task item to indicate that the particular task item has been scheduled;
automatically updating a resource task schedule for the particular resource to include a particular entry for the particular task item at a particular time; wherein the updated resource task schedule also includes one or more other entries for one or more other task items scheduled at one or more other times;
automatically updating the map to include a graphical indication that is based at least in part on both the particular task location and the particular resource location.

17. The system of claim 16, wherein the graphical indication comprises one or more graphically displayed routes between the particular resource location and the particular task location.

18. The system of claim 16, wherein the graphical indication comprises metadata that is based on one or more metrics predicted for a trip between the particular resource location and the particular task location.

19. The system of claim 16, wherein receiving the selection of the particular task item of the one or more selectable task items comprises receiving input that drags the particular task item from a task item region of a user interface to the map; wherein the map is in a map region of the user interface.

20. The system of claim 16, wherein receiving the selection of the particular task item of the one or more selectable task items comprises receiving a selection of the particular resource among two or more displayed resources of the subset.
